(19) United States
(12) Patent Application Publication
(10) Pub. No.: US 2007/0105571 A1
(43) Pub. Date: May 10, 2007

(54) System and method for providing advertisement messages

(76) Inventors: Ho-Sung Choi, Seoul (KR); Sung-Bin Im, Seoul (KR); Min-Seok Kim, Gyeonggi-do (KR)

Correspondence Address: LADAS & PARRY LLP, 224 SOUTH MICHIGAN AVENUE, SUITE 1600, CHICAGO, IL, 60604, US

(21) Appl. No.: 11/482,291

(22) Filed: Jul. 7, 2006

(30) Foreign Application Priority Data
Nov. 4, 2005 (KR) 10-2005-0105486

(51) Int. Cl. H04Q 7/20

(52) U.S. Cl. 455/466; 709/201; 705/14; 340/7.48

(57) ABSTRACT

Disclosed herein are a system and method for providing advertisement messages. The system includes a message transmission condition setting unit, a Virtual Machine (VM) application provision unit, a message transmission target extraction unit, and a message transmission unit. The message transmission condition setting unit classifies message transmission conditions according to a user and stores the classified message transmission conditions in the DB, based on a preset message transmission condition menu. The VM application provision unit extracts the VM application and transmits the extracted VM application to the mobile communication terminal. The message transmission target extraction unit extracts an advertisement message transmission target based on message transmission conditions for the respective users. The message transmission unit transmits the advertisement message to the mobile communication terminal of the corresponding user, which is chosen as an advertisement message transmission target by the message transmission target extraction unit and has been provided with the VM application.

### BACKGROUND OF THE INVENTION

1. Field of the Invention

The present invention relates generally to a system for providing advertisement messages and, more particularly, to a system and method for providing advertisement messages, which transmit the advertisement messages to users according to preset conditions, and allow the advertisement messages to be separately managed.

2. Description of the Related Art

As the number of users who carry mobile communication terminals is increasing, service operators are transmitting advertisement messages for publicizing their services or products to the mobile communication terminals, so that the users may view the advertisement messages.

However, the advertisement messages are frequently transmitted to the users' mobile communication terminals without previous consultation with the users, so that the users increasingly regard most of the advertisement messages that are received by their mobile communication terminals as spam messages and delete the received advertisement messages without viewing them.

Accordingly, research is required research into a method in which service operators provide advertisement messages to users differently from the existing method of transmitting advertisement messages.

### SUMMARY OF THE INVENTION

Accordingly, the present invention has been made keeping in mind the above problems occurring in the prior art, and an object of the present invention is to provide a system and method for providing advertisement messages, which provide corresponding advertisement messages only to specific users according to advertisement message transmission conditions set by the users.

Furthermore, another object of the present invention is to provide a system and method for providing advertisement messages, which provide a Virtual Machine (VM) application, having functions for separately managing and storing advertisement messages received by each user's mobile communication terminal, thus allowing the advertisement messages to be viewed according to users' settings.

In order to accomplish the above object, the present invention provides a system for providing advertisement messages, the system being connected with a mobile communication network and transmitting advertisement messages to a mobile communication terminal in which a Virtual Machine (VM) application for receiving the advertisement messages is installed, the system including a DataBase (DB) for storing information associated with the advertisement message provision system, as well as collected and registered advertisement messages; a message transmission condition setting unit for classifying message transmission conditions, which users register using wired or wireless terminals, according to a user and storing the classified message transmission conditions in the DB, based on a preset message transmission condition menu; a VM application provision unit for extracting the VM application, which has been previously stored, and transmitting the extracted VM application to the mobile communication terminal of a user desiring to receive advertisement messages; a message transmission target extraction unit for, when a request from an operator or a registration for a new advertisement message is made, extracting an advertisement message transmission target based on message transmission conditions for the respective users, which have been registered in the DB by the message transmission condition setting unit; and a message transmission unit for transmitting the advertisement message to the mobile communication terminal of the corresponding user, which is chosen as an advertisement message transmission target by the message transmission target extraction unit and has been provided with the VM application.

In addition, the present invention provides a method for providing advertisement messages, using a system for providing advertisement messages, that is connected to a mobile communication network and transmits the advertisement messages to a mobile communication terminal in which a VM application for receiving the advertisement messages has been installed, the system having a DB for storing collected and registered advertisement messages, the method including the steps of (a) classifying message transmission conditions, which are registered by users using a wired or wireless terminal, according to a user and storing the classified message transmission conditions in the DB, based on a preset message transmission condition menu; (b) when a request from an operator or a registration for a new advertisement message is made, extracting an advertisement message transmission target based on message transmission conditions for the respective users, which have been registered in the DB by the message transmission condition setting unit; and (c) transmitting the advertisement message to the mobile communication terminal of the corresponding user, which is chosen as an advertisement message transmission target at step (b) and has been provided with the VM application.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing a connection between a system for providing advertisement messages and a communication network according to the present invention;

FIG. 2 is a block diagram showing the construction of the system for providing advertisement messages according to the present invention in detail;

FIG. 3 is a block diagram showing the construction of a mobile communication terminal according to the present invention; and

FIG. 4 is a flowchart illustrating a method of providing advertisement messages according to the present invention.

### DESCRIPTION OF THE PREFERRED EMBODIMENTS

The advertisement message disclosed in the present invention has a short message form or a multimedia message form, including any of text, a still image, a moving image or a combination thereof.

A preferred embodiment of the present invention is described in detail with reference to the accompanying drawings below.

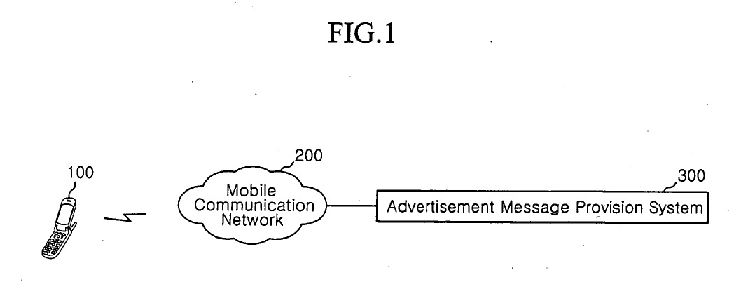

FIG. 1 is a diagram showing a connection between a system for providing advertisement messages and a communication network according to the present invention.

The advertisement message provision system 300 stores advertisement messages collected from a plurality of content servers (not shown) or registered by advertisement providers through a mobile communication network 200, and transmits an advertisement message to a mobile communication terminal 100 based on message transmission conditions that a user sets using a preset message transmission condition menu.

In this case, a VM application is downloaded from the advertisement message provision system 300, is stored and installed in the mobile communication terminal 100 in order to receive the advertisement messages, and separately stores and manages the advertisement messages transmitted from the advertisement message provision system 300. Each of the advertisement messages includes information about the call-back URL of a server that provides information about the details of each item in the advertisement message, so that, when the user manipulates a terminal and selects a specific item from the advertisement message, a connection to the server that provides the details can be made using the call-back URL.

The advertisement message provision system 300, illustrated in FIG. 1, may be connected to a plurality of content provision servers (not shown) that request the transmission of advertisement messages, or may be implemented as part of an individual business's corporate management server.

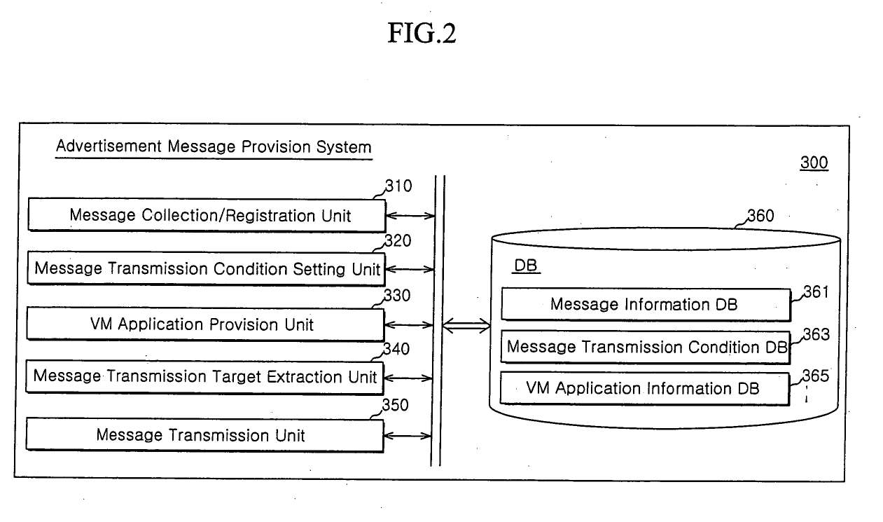

FIG. 2 is a block diagram showing the construction of the system for providing advertisement messages according to the present invention in detail.

As shown in FIG. 2, the advertisement message provision system 300 includes a message collection/registration unit 310, a message transmission condition setting unit 320, a VM application provision unit 330, a message transmission target extraction unit 340, a message transmission unit 350, and a DB 360.

In more detail, the DB 360 includes a message information DB 361 for storing the collected and registered advertisement messages, a message transmission condition DB 363 for storing message transmission conditions that users register using wired or wireless terminals, and a VM application information DB 365 for storing information about a VM application that is installed in the mobile communication terminal 100 and then has a function of separately managing advertisement messages, which are received from the advertisement message provision system 300, in the mobile communication terminal 100.

The message collection/registration unit 310 stores the advertisement messages, which are collected from the plurality of content provision servers or are registered by the advertisement providers, in the message information DB 361, and allows an advertisement message transmission procedure to be performed by transferring the advertisement messages to the message transmission target extraction unit 340 and the message transmission unit 350 at the time of storing the advertisement messages.

Each of the advertisement messages includes information about the call-back URL of a server that provides information about the details of each item in the advertisement message, so that, when the user manipulates a terminal and selects a specific item from the advertisement message, a connection to the server that provides the details can be made using the call-back URL.

Based on a preset message transmission condition menu, the message transmission condition setting unit 320 classifies message transmission conditions, which users register using wired or wireless terminals, according to a user and stores the classified message transmission conditions in the message transmission condition DB 363. In this case, the message transmission conditions may be any of the conditions for transmitting advertisement messages matched to a field that a user selects according to his or her preference, conditions for transmitting advertisement messages associated with a specific business designated by the user, conditions for transmitting all advertisement messages, and the combinations thereof.

The VM application provision unit 330 extracts a previously stored VM application and transmits the extracted VM application to the mobile communication terminal 100 of a user who desires to receive the advertisement message. The VM application has functions of storing the advertisement messages, which are transmitted from the advertisement message provision system 300, in a separate advertisement message storage space provided in the mobile communication terminal 100, and providing the stored advertisement messages at the user's request, after transmission to the mobile communication terminal 100 and installation.

When a request from an operator or a registration for a new advertisement message is made, the message transmission target extraction unit 340 extracts an advertisement message transmission target based on the message transmission conditions for each user, which have been registered in the message transmission condition DB 363 by the message transmission condition setting unit 320.

The message transmission unit 350 transmits an advertisement message to the mobile communication terminal 100 of the corresponding user, which is chosen as an advertisement message transmission target by the message transmission target extraction unit 340 and has been provided with the VM application.

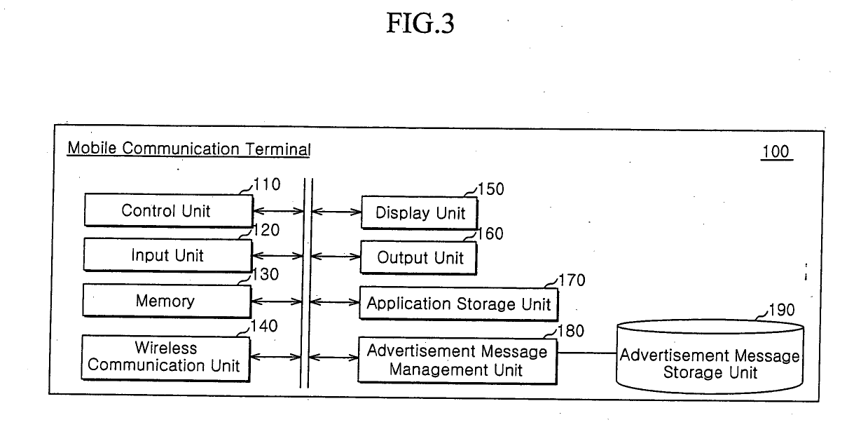

FIG. 3 is a block diagram showing the construction of a mobile communication terminal according to the present invention.

As shown in FIG. 3, the mobile communication terminal 100 includes a control unit 110, an input unit 120, memory 130, a wireless communication unit 140, a display unit 150, an output unit 160, an application storage unit 170, an advertisement message management unit 180, and an advertisement message storage unit 190.

Since the control unit 110 for the overall operation of the mobile communication terminal 100, the input unit 120 for controlling the input of the mobile communication terminal 100, the memory 130 for storing various pieces of data, the wireless communication unit 140 for performing wireless communication, a display unit 150 for displaying the current state of a mobile communication terminal or the processed state of an event that a user has requested, and an output unit 160 for audibly providing data, which is necessary for the use of voice call service or data service, are general elements of mobile communication terminals, a description thereof is omitted.

The application storage unit 170 receives and stores the VM application transmitted from the advertisement message provision system 300, and installs the VM application in the mobile communication terminal 100, thus allowing the VM application to separately manage the advertisement transmitted from the advertisement message provision system 300.

When the advertisement messages transmitted from the advertisement message provision system 300 are received according to the message transmission conditions registered by the user, the advertisement message management unit 180 stores the received advertisement messages in the advertisement message storage unit 190.

Furthermore, the advertisement message management unit 180 displays the advertisement messages through the display unit 150 immediately after receiving the advertisement messages, which have been stored in the advertisement message storage unit 190, according to preset message display conditions, or extracts advertisement message from the advertisement message storage unit 190 and displays the extracted advertisement message through the display unit 150 at the user's request. Each of the advertisement messages includes information about the call-back URL of a server that provides information about the details of each item of the advertisement message, so that, when the user manipulates a terminal and selects a specific item from the advertisement message, a connection to the server that provides the details can be made using the call-back URL.

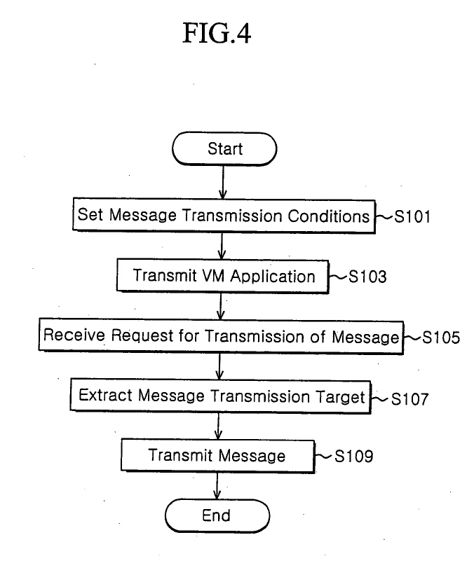

FIG. 4 is a flowchart illustrating a method of providing advertisement messages according to the present invention.

The advertisement message provision system 300, disclosed in conjunction with FIG. 4, stores advertisement messages, which are collected from a plurality of content provision servers or are registered by advertisement providers, in the message information DB 361.

The message transmission condition setting unit 320 of the advertisement message provision system 300 classifies message transmission conditions, which users register by using wired or wireless terminals, according to a user and stores the classified message transmission conditions in the message transmission condition DB 363, based on a preset message transmission condition menu at step S101. In this case, the message transmission conditions may be any of the conditions for transmitting advertisement messages matched to a field selected by a user according to his or her preference, conditions for transmitting advertisement messages associated with a specific business designated by the user, conditions for transmitting all advertisement messages, and the combinations thereof.

The VM application provision unit 330 extracts the VM application, which has been previously stored in the VM application information DB 365, and transmits the extracted VM application to the mobile communication terminal 100 of a user, desiring to receive the advertisement messages, in response to a request transmitted from the mobile communication terminal 100 at step S103. In this case, the VM application stores the advertisement messages, transmitted from the advertisement message provision system 300, in the separate advertisement message storage space provided in the mobile communication terminal 100, and provides the stored advertisement messages at the user's request, after transmission to the mobile communication terminal 100 and installation.

Thereafter, when a request from an operator or a registration for a new advertisement message is made at step S105, the message transmission target extraction unit 340 extracts an advertisement message transmission target based on message transmission conditions for the respective users, which have been registered in the message transmission condition DB 363, at step S107.

The message transmission unit 350 transmits the advertisement message to the mobile communication terminal 100 of the corresponding user, which is chosen as an advertisement message transmission target at step S107 and has been provided with the VM application.

Each of the advertisement messages, disclosed in conjunction with FIG. 4, includes information about the call-back URL of a server that provides information about the details of each item of the advertisement message, so that, when the user manipulates a terminal and selects a specific item from the advertisement message, a connection to the server that provides the details can be made using the call-back URL.

As described above, the system and method for providing advertisement messages transmit advertisement messages to users' mobile communication terminals according to preset conditions, so that they are advantageous in that advertisement messages differentiated from existing spam messages can be provided and, therefore, the advertisement effect can be improved.

Furthermore, the present invention provides a VM application, which allows received advertisement messages to be separately stored and managed, to the mobile communication terminals, so that it is advantageous in that advertisement messages can be viewed according to a user's settings.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A system for providing advertisement messages, the system being connected with a mobile communication network and transmitting advertisement messages to a mobile communication terminal in which a Virtual Machine (VM) application for receiving the advertisement messages is installed, the system comprising:
a DataBase (DB) for storing information associated with the advertisement message provision system, as well as collected and registered advertisement messages;
a message transmission condition setting unit for classifying message transmission conditions, which users register using wired or wireless terminals, according to a user and storing the classified message transmission conditions in the DB, based on a preset message transmission condition menu;
a VM application provision unit for extracting the VM application, which has been previously stored, and transmitting the extracted VM application to a mobile communication terminal of a user desiring to receive advertisement messages;
a message transmission target extraction unit for, when a request from an operator or a registration for a new advertisement message is made, extracting an advertisement message transmission target based on message transmission conditions for the respective users, which have been registered in the DB by the message transmission condition setting unit; and
a message transmission unit for transmitting the advertisement message to the mobile communication terminal of the corresponding user, which is chosen as an advertisement message transmission target by the message transmission target extraction unit and has been provided with the VM application.

2. The system as set forth in claim 1, further comprising a message collection/registration unit for storing advertisement messages, which are collected from a plurality of content provision servers or registered by advertisement providers, in the DB.

3. The system as set forth in claim 1, wherein, after installation in the mobile communication terminal, the VM application stores the advertisement message, which is transmitted from the advertisement message provision system, in a separate advertisement message storage space provided in the mobile communication terminal, and provides the stored advertisement message at the user's request.

4. The system as set forth in claim 1, wherein the message transmission conditions are any of the conditions for transmitting advertisement messages matched to a field selected by a user according to his or her preference, conditions for transmitting advertisement messages associated with a specific business designated by the user, conditions for transmitting all advertisement messages, and combinations thereof.

5. The system as set forth in claim 1, wherein the advertisement message includes information about a call-back Uniform Resource Locator (URL) of a server that provides information about details of each item in the advertisement message.

6. A method for providing advertisement messages using a system for providing advertisement messages that is connected to a mobile communication network and transmits the advertisement messages to a mobile communication terminal in which a VM application for receiving the advertisement messages has been installed, the system having a DB for storing collected and registered advertisement messages, the method comprising the steps of:
(a) classifying message transmission conditions, which are registered by users using a wired or wireless terminal, according to a user and storing the classified message transmission conditions in the DB, based on a preset message transmission condition menu;
(b) when a request from an operator or a registration for a new advertisement message is made, extracting an advertisement message transmission target based on message transmission conditions for the respective users, which have been registered in the DB by the message transmission condition setting unit; and
(c) transmitting the advertisement message to the mobile communication terminal of the corresponding user, which is chosen as an advertisement message transmission target at step (b) and has been provided with the VM application.

7. The method as set forth in claim 6, wherein the advertisement message provision system is connected to a plurality of content provision servers that provide supplementary service;
further comprising, before step (a), the step of storing advertisement messages collected from the plurality of content provision servers or registered by advertisement providers.

8. The method as set forth in claim 6, wherein, before step (b), the advertisement message provision system extracts the VM application that has been previously stored, and transmits the extracted VM application to a mobile communication terminal of a user desiring to receive the advertisement messages.

9. The method as set forth in claim 8, wherein, after being installed in the mobile communication terminal, the VM application stores the advertisement messages, transmitted from the advertisement message provision system, in a separate advertisement message storage space provided in the mobile communication terminal, and provides the stored advertisement messages at the user's request.

10. The method as set forth in claim 6, wherein the message transmission conditions are any of the conditions for transmitting advertisement messages matched to a field selected by a user according to his or her preference, conditions for transmitting advertisement messages associated with a specific business designated by the user, conditions for transmitting all advertisement messages, and combinations thereof.

11. The method as set forth in claim 6, wherein each of the advertisement messages includes information about a call-back URL of a server that provides information about details of each item in the advertisement message.
